(19) United States
(12) Patent Application Publication
(10) Pub. No.: US 2007/0047585 A1
(43) Pub. Date: Mar. 1, 2007

(54) Methods and apparatus for network address change for mobile devices

(75) Inventors: Brian Gillespie, Dublin (IE); Helmut Salmen, Los Gatos, CA (US); David Tracey, Drogheda (IE)

Correspondence Address: WOLF GREENFIELD & SACKS, PC, FEDERAL RESERVE PLAZA, 600 ATLANTIC AVENUE, BOSTON, MA, 02210-2206, US

(73) Assignee: XDS Inc., Boston, MA (US)

(21) Appl. No.: 11/473,779

(22) Filed: Jun. 23, 2006

Related U.S. Application Data
(60) Provisional application No. 60/693,552, filed on Jun. 23, 2005.

(51) Int. Cl. H04J 3/24

(52) U.S. Cl. 370/475

(57) ABSTRACT

In one aspect, a system capable of performing network address changes is provided. The system comprises a network interconnecting a plurality of hosts, a mobile device connected to the network, the mobile device associated with a first network address corresponding to a first network location of the mobile device on the network, a first host connected to the network, and a mobile handler capable of communicating with the mobile device and the host over the network. Wherein the mobile handler is configured to receive a change of address request from the mobile device, the change of address request including a second network address corresponding to a second network location of the mobile device on the network, the mobile handler configured to notify the first host of the change of address request, the notification including the second network address, and wherein the first host is adapted to receive the notification and to initiate a connection with the mobile device at the second network address, wherein a communication path of the connection does not include the mobile handler.

### RELATED APPLICATION

This application claims priority under 35 U.S.C. § 119(e) to U.S. Provisional Application Ser. No. 60/693,552, entitled “Secure and Scalable IP Network Address Change Scheme for Mobile Hosts Using a Trusted Third Party,” filed on Jun. 23, 2005, which is herein incorporated by reference in its entirety.

### FIELD OF THE INVENTION

The present invention relates to computer networking, and more particularly, to mobile devices connected to a network, wherein the mobile device may change its network address due to, for example, loss of connection, roaming, lease expiration, etc.

### BACKGROUND OF INVENTION

With the increased proliferation of wireless network technologies, and the ever decreasing cost of hi-speed networks based on these technologies, more computing devices are being attached to networks over wireless connections. The flexibility offered by wireless technology permits mobile devices such as personal computers (PC), cellular telephones, personal desktop assistants (PDA), and other portable computing devices to be operated in many different locations.

In contrast to traditional wired computing devices that are typically permanently or semi-permanently associated with a single location and can often have a statically assigned network address at the location, a mobile device may require a new network address as it changes from location to location. That is, the different locations in which a mobile device may operate may require different network addresses with which to correctly locate the mobile device. For example, networks operated by different service providers may require a mobile device to change its network address while being attached to a particular network. Accordingly, in the wireless model, a mobile device may be assigned a different network address for each wireless location in which it is used. In highly mobile environments, a mobile device may be allowed to roam from network to network, thus requiring network address changes that may need to be performed dynamically, particularly when the device is currently in communication with one or more network devices when the network address change is required.

To resolve problems of network address change in wireless networks connected to by mobile devices, a general solution to support mobile devices using Transport Control Protocol (TCP)/Internet Protocol (IP) is described in Internet Engineering Task Force Request for Comments (RFC) 2002, 3220 and 3344, which propose Internet standards for mobility under Internet Protocol Version 4 (IPv4). In this scheme, each mobile device is associated with what is known as a home network. When a mobile device is participating in an end-to-end communications with a host, the host always communicates with the mobile device at the address associated with the mobile device's home network, even if the mobile device moves to a different network, referred to herein as a foreign network (e.g., a network serviced by a provider different than the provider of the home network).

When the mobile device is located within its home network, then the routing of datagrams (e.g., network packets) between the host and mobile device may function as per normal IP routing. For example, in IPv4, network addresses comprise 32 bits of binary data divided into a network identifier portion and a host identifier portion. Network identifiers and host identifiers can use different numbers of the 32 bit address. The greater number of bits used for the host identifier portion, the more hosts that can be attached to the associated network. Network hosts are connected to local networks and use their host identifier portion to identify themselves uniquely on that network. The network identifier portion differentiates one network from another network. Networks are typically inter-connected via one or more devices called routers.

Accordingly, when one or more network packets are exchanged between a mobile device and a host on its home network, the network packets may be directly routed using the host identifier portions of the respective network addresses. The network packet can be directly sent to the data link layer of the destination host, for example, the mobile device and/or the host to which the mobile device is connected.

When the mobile device is located in a foreign network (i.e., any network other than its home network), the home network forwards the network packets or datagrams to the network on which the mobile device is currently located. The home network performs this forwarding operation substantially transparent to the host and the routers located between the host and the home network. In particular, the host communicating with the mobile device may not be aware of the change of network address because the re-directing of the data packet occurs downstream from the host, as discussed in further detail below. When the mobile device is located outside its home network, it is given a care-of-address in the foreign network to which the home network forwards any packets intended for the mobile device. This care-of-address is a temporary address for the duration of the mobile device's stay in the foreign network.

To enable a mobile device to roam away from its home network, the home network must provide a special router known as a home agent that is responsible for forwarding packets to the mobile device when it is located in a foreign network. In each foreign network that a mobile device may be attached and/or located, a special router known as a foreign agent is normally present to act on behalf of the mobile device. The foreign agent may operate, for example, as the mobile device's default router in the foreign network. In some instances, the care-of-address, which is known by the home agent, is the network address of the foreign agent. The foreign agent, on receipt of network packets from the home agent, forwards the network packets on to the mobile device. Accordingly, the home and foreign agents (referred to generically as mobility agents) are aware of the network address change, but the host and other routers are not, since the home and foreign agents operate as proxies for the old and new network addresses, respectively.

This framework is an extension overcomes a substantial difficulty in IPv4 without mobility support. In particular, when multiple networks are involved, routers maintain routing tables describing where incoming network packets should be sent to find the destination network. Routers co-operate with one another, using various routing protocols, exchanging information about how to reach different networks through a process known as next-hop-routing.

These routing protocols relate to network routing discovery, not host discovery. The IPv4 address space is sufficiently large as to make it prohibitively expensive and inefficient to maintain individual routes for all hosts. Further, because IPv4 addresses couple the network identifier and host identifier so tightly and because the number of host identifiers available in a given network varies from network to network, it may not be possible to devise a scheme whereby a client change of address could be communicated as a network identifier change while maintaining its host identifier. The mobile network extension described above resolves this difficulty.

A mobile device typically locates and identifies a foreign agent through agent advertisement. This process, referred to as agent discovery, involves mobility agents periodically broadcasting their services across the network that the mobility agent services. Since a mobility agent broadcasts its advertisements local to the network on which the agent operates, the mobile device can both determine whether it is in its home or a foreign network, and locate a foreign agent when it determines that it has left its home network. When the mobile device discovers that it is in a foreign network and locates a foreign agent, the mobile device then forwards the care-of-address (e.g., the foreign agent's network address obtained from the advertisement) to its home agent to register and establish the communication path that permits the forwarding of network packets intended for the mobile device.

### SUMMARY OF INVENTION

One embodiment of the present invention includes a method for changing a first network address of a mobile device connected to a network at a first network address, the mobile device having a connection to a host over the network, the change of network address being processed by a mobile handler connected over the network to both the mobile client and the host. The method comprises acts of transmitting a change of address request, from the mobile device to the mobile handler, the change of address request including a second network address, providing a notification of the change of address request, from the mobile handler to the host, the notification including the second network address, modifying, by the host, the connection between the host and the mobile client to use the second network address in communicating with the mobile client, and communicating between the host and the mobile client over the modified connection, wherein a communication path of the modified connection does not include the mobile handler.

Another embodiment of the present invention includes a system capable of performing network address changes, the system comprising a network interconnecting a plurality of hosts, a mobile device connected to the network, the mobile device associated with a first network address corresponding to a first network location of the mobile device on the network, a first host connected to the network, and a mobile handler capable of communicating with the mobile device and the host over the network. Wherein the mobile handler is configured to receive a change of address request from the mobile device, the change of address request including a second network address corresponding to a second network location of the mobile device on the network, the mobile handler configured to notify the first host of the change of address request, the notification including the second network address, and wherein the first host is adapted to receive the notification and to initiate a connection with the mobile device at the second network address, wherein a communication path of the connection does not include the mobile handler.

Another embodiment of the present invention includes a network device for facilitating a change in a first network address of a mobile device having a connection to a host over a network, wherein the connection uses a first network address for the mobile device, the network device comprising at least one network port to allow the network device to be connected to the network, a controller connected to the at least one network port, the controller adapted to process a change of address request received at the at least one network port from the mobile device, the change of address request including a second network address, the controller further adapted to transmit at least the second network address to the host to notify the host of the change of address request. Wherein subsequent communications between the host and the mobile device over a connection established at the second network address is over a communication path that does not include the network device.

### BRIEF DESCRIPTION OF DRAWINGS

FIG. 1A-1I illustrate a system for implementing a mobility network that facilitates change of network addresses for mobile devices, in accordance with one embodiment of the present invention;

FIG. 2A-2C illustrates a system for implementing a mobility network that facilitates change of network addresses for mobile devices communicating with a server located behind a firewall, in accordance with another embodiment of the present invention; and

FIG. 3A-3D illustrates a system for implementing a mobility network that facilitates change of network addresses for mobile stateless devices, in accordance with another embodiment of the present invention.

### DETAILED DESCRIPTION

As discussed above, conventional device mobility may be achieved via a framework in which each mobile network is assigned a home network having a home agent that operates on behalf of the mobile device. In addition, a mobile device may require a foreign agent in each foreign network to which the mobile device may roam to operate as a proxy that forwards communications received from the home agent to the mobile device at its location on the foreign network. The Applicant has appreciated that there are a number of drawbacks to the conventional solution to network mobility.

In particular, the requirement that a mobile device have a designated home network may be inflexible. The home network framework is modeled on the assumption that a mobile device will typically be located in its designated home network. As network mobility and inter-network roaming become increasingly widespread and ubiquitous, it may not be clear which network should be considered a home network for a particular mobile device, making the framework difficult to administer and use.

In addition, the routing of network packets (e.g., datagrams) via the home network is inefficient. In particular, a given host and mobile device engaged in an end-to-end communication may be closer to each other, from a network standpoint, then they are to the designated home network. Thus, network packets exchanged between the host and the mobile client may have to be inefficiently re-routed through the home network via the home agent. This adversely affects the scalability of the network mobility solution. For example, as the number of mobile devices increase, the inefficiencies introduced by the requirements of the conventional framework may have negative impacts on network bandwidth. Routing data packets through home and foreign agents may incur substantial and unnecessary network traffic, and inefficient routing creates unnecessary latency between the endpoints, thus adversely impacting the quality of the transmission.

The implementation of mobility agents (i.e., home and foreign agents) requires additional and specialized routers configured to provide advertisements, accept registrations, perform various forwarding capabilities, and/or handle other proxy services on behalf of the mobile device. This additional network infrastructure must be deployed in the home network and on any foreign networks in which a mobile device is expected to roam, making widespread, highly mobile networks costly to implement and expensive to administer and maintain. For example, network roaming may be limited to networks that have implemented and comply with the mobility agent framework described above.

To further limit the applicability of the above described conventional network mobility techniques, current solutions are formulated as extensions of IP network implementations, thus limiting the types of networks on which these techniques may be implemented. A mobile device may wish to access a non-IP based network and/or attach to a network only accessible from outside its home network (which by definition, must be IP-based). If any connecting networks are not IP-based, the mobile client will not be able to roam to those networks, at least not while communicating simultaneously with a host connected over a compliant IP-based network. The requirement that both the home network and any foreign network to which a mobile device might attach be IP-based reduces the availability of networks for mobile devices.

As discussed above, when a mobile device is roaming, the mobile device may need to request or be assigned a new network address for the newly entered network. In conventional mobility networks, this may entail responding to an advertisement from a foreign agent or otherwise soliciting assistance from a foreign agent and registering the new address with the home network (e.g., via the home agent). The situation is complicated when the device is not merely attaching to a foreign network, but roaming simultaneous to communicating with one or more remote networked hosts. In these instances, the hosts currently communicating with the mobile device would continue to transmit packets to the previous mobile device's network address.

Either the host, or some other device such as a router, acting on behalf of the mobile device and/or host, must be informed of the mobile device's change of address to allow the redirection of the communications to the new address, preferably without having to stop and reestablish/restart the connection between the host and the mobile device, and/or repeat any authentication process already performed. As a result, the conventional change of address procedures are vulnerable to security breaches. For example, a malicious network device may attempt to commandeer communications between the host(s) and the mobile device either during an interval of time when the host(s) is still transmitting packets to the previous address and/or by forging a change of address procedure to redirect communications to the malicious network device.

The Applicant has appreciated that one or more of the above shortcomings may be eliminated by implementing a mobility network adapted to handle communications in a highly mobile environment where mobile devices may require network address changes, perhaps on a relatively frequent basis. For example, in one embodiment, the network architecture described in U.S. patent application Ser. No. 10/328,660 ('660), entitled “System and Method for Provisioning Universal Stateless Digital and Computing Services,” filed on Dec. 23, 2002, may be used as a model to facilitate device mobility such that a mobile device may automatically, securely, seamlessly and dynamically change its network address while participating in an already established end-to-end communications with another host computer over a packet oriented, untrusted network, maintaining communication through the network address change. The '660 application is herein incorporated by reference in its entirety.

In one embodiment, both the host and the mobile device are connected, or are configured to be capable of connecting, to a third party device referred to as a mobile handler (MH). The MH is generally trusted by both the mobile device and the host. For example, the host may recognize communications from the MH and trust that the information was not transmitted from a malicious network device. The mobile device and host may communicate with the MH to exchange information to authenticate the mobile device and perform a change of network address for the mobile device, thus enabling the host to communicate with the mobile device at the new network address. The change of network address may occur for any of numerous reasons, for example, in the event of a network handover resulting from the mobile device roaming between and/or attaching to a different network, and/or a loss of connection with the current network, etc.

Following below are more detailed descriptions of various concepts related to, and embodiments of, methods and apparatus according to the present invention. It should be appreciated that various aspects of the invention described herein may be implemented in any of numerous ways. Examples of specific implementations are provided herein for illustrative purposes only. In particular, any of various network implementations and configurations using any of various networks, network protocols, etc., may be used, as the aspects of the invention are not limited to any particular type of network, network configurations, and/or network devices.

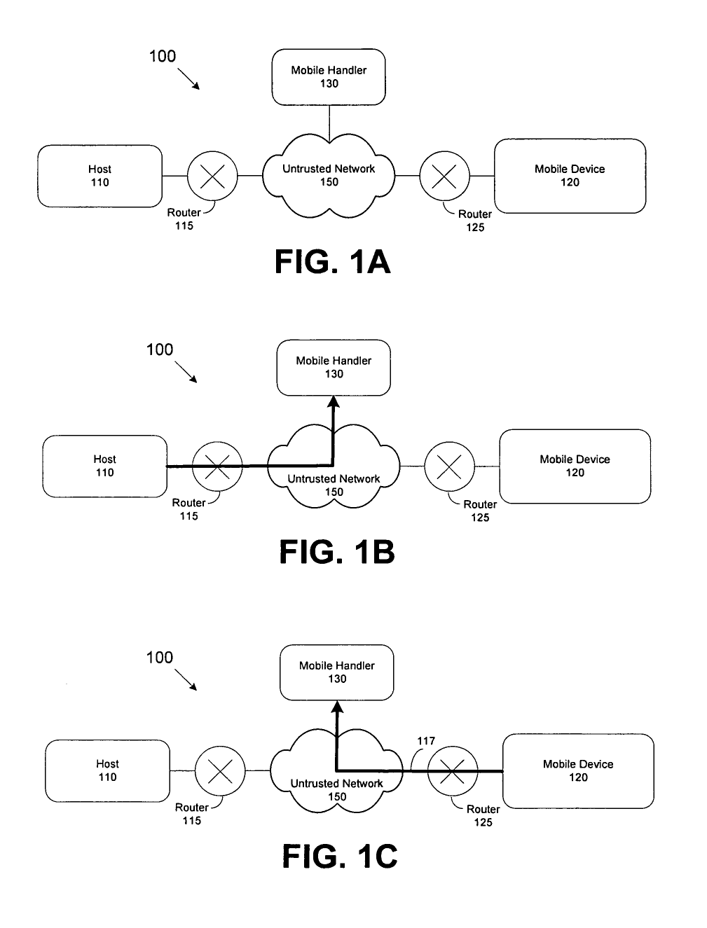

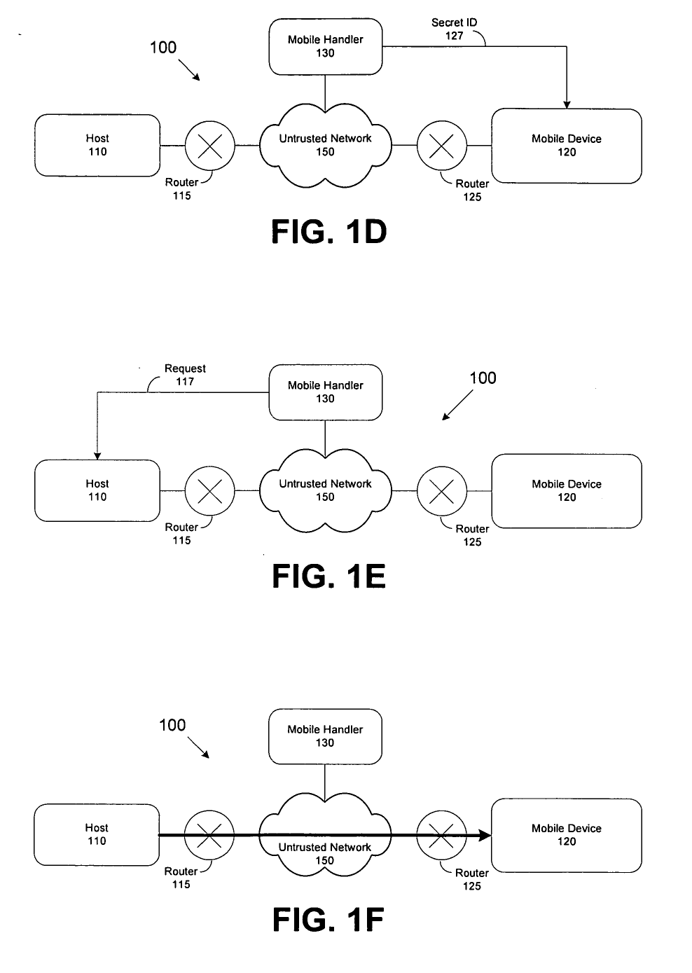

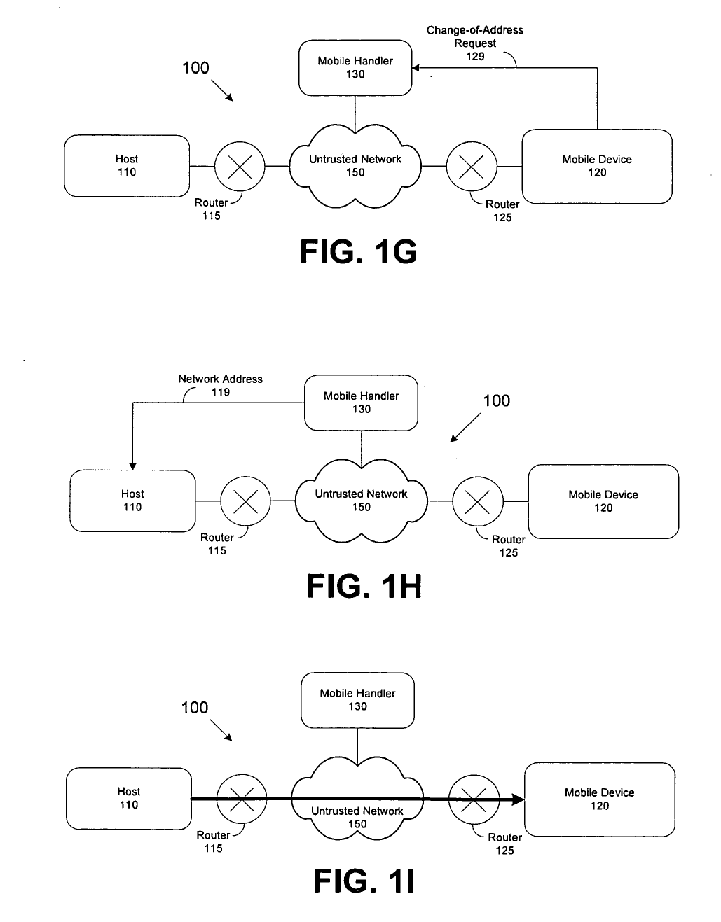

FIG. 1 illustrates a system for implementing a mobility network, in accordance with one embodiment of the present invention. System 100 includes a host 110 connected to an untrusted network 150 (e.g., the Internet) via router 115. System 100 also includes mobile device 120 connected to untrusted network 150 via router 125. Mobile device 120 may be connected to the network 150 via a wireless link. For example, router 125 may include one or more wireless access points that wirelessly connect the mobile device to network 150. The mobile device 120 may be unknown to and untrusted by host 110. However, this is not a limitation on the aspects of the invention, as mobile device 120 may be either known, trusted or both. System 100 also includes a MH 130, which is connected to the untrusted network 150 and facilitates establishing a communication link between mobile device 120 and host 110. The host and/or the MH may also be connected to network 150 via a wireless link.

It should be appreciated that network 150 may be comprised of a plurality of networks of any type and configuration. For example, network 150 may include numerous networks, each network identified by a different network identifier portion of the network addresses issued by the various network devices connected to the network. Network 150 may include one or more private networks, local area networks (LAN), wide area networks (WAN), the Internet, etc., as the aspects of the invention are not limited in this respect. Network 150 may include one or more cooperating routers that direct network traffic between different networks, facilitating roaming by mobile devices connected to the network.

MH 130 is generally known to and trusted by host 110 and may have a trusted link established with the host by which the MH can communicate information to the host. For example, the host may be connected to the MH via a Transport Control Protocol (TCP) connection or in the Secure Sockets Layer (SSL). As shown in FIG. 1B, host 110 may initiate and establish a communication link with MH. Alternatively, MH 130 can initiate the link. However, by having the host initiate the process, host 110 can have greater control over the process to ensure that MH 130 is trusted. Host 110 may perform any type of security measure or authentication procedure it would like to satisfy itself of the MH's authenticity and trustworthiness.

Similarly, MH 130 is generally known to and trusted by mobile device 120. Mobile device 120 may be configured to connect to and interact with MH 130 when it desires communication with host 110. Mobile device 120 may want to use one or more services provided by host 110. As a result, MH 130 operates as a trusted intermediary between mobile device 120 and host 110. It should be appreciated that MH 130 may be connected to multiple hosts and multiple mobile devices to operate as a generally trusted intermediary between any number of trusted and/or untrusted mobile device/host pairs, as the aspects of the invention are not limited in this respect.

As shown in FIG. 1C, the mobile device may connect to MH 130 via a network connection 117 (e.g., and encrypted connection such as SSL, or any other type of connection). When the mobile device connects with MH 130, a temporary identity for the mobile device is established for the purposes of authentication. The temporary identity may be comprised of a secret identifier (ID) and a unique network identity (e.g., the mobile device's IP address). The temporary identity may be comprised of different or additional identifiers that serve to securely identify the mobile device, as the aspects of the invention are not limited in this respect. That is, the MH may use any of various authentication schemes that can uniquely identify the mobile device and that facilitate prevention of malicious devices spoofing the identity of the mobile device (e.g., to prevent a bad actor from representing itself to be the authorized mobile device to gain access to one or more services and/or to obtain data or other confidential information).

MH 130 obtains the network address of the mobile device used to establish the connection, and generates secret ID 127 to form a unique identifier of the mobile device. For example, the MH may generate a random number as the secret ID. In some embodiments, the secret ID is generated randomly and independent of any known or knowable attributes associated with either the MH or the mobile device to ensure that the secret ID cannot be easily guessed by a malicious attacker attempting to spoof the identity of the mobile device. For example, the MH may generate a random integer value of at least 128 bits, wherein the integer value is unrelated to the IP address, hardware address, geographical location, etc., of the MH or the mobile device. The secret ID and the network ID may together operate as proof, to the MH, of the mobile device's identity.

As shown in FIG. 1D, MH 130 forwards secret ID 127 over the link established between the mobile device and the MH. The MH and the mobile device may be the only entities in possession of the secret ID, which is retained by both for authentication until the mobile device restarts, reboots or otherwise undergoes an operation causing the secret ID to expire. While the network address and secret ID operate as the authentication mechanism, any method of authentication that securely identifies the mobile device may be used, as the aspects of the invention are not limited in this respect.

In FIG. 1E, MH 130 notifies host 110 that mobile device 120 would like to connect with the host. The notification from MH 130 may include the network address of the mobile device, and may include any additional information needed and/or desired by host 110 (e.g., one or more services that the mobile device is requesting). The host 110 then initiates and establishes a communication link with the mobile device using the information (e.g., the network address) supplied to it by MH 130, as shown in FIG. 1F. The mobile device and the host are then free to communicate over this established link. Once the connection between the host 110 and mobile device 120 is established, the MH is no longer involved in subsequent communication over the establish link. That is, the communication path through the untrusted network does not include MH 130. Thus, the MH operates as an intermediary to establish the connection, but not during the resulting communication over the connection.

At some point during the communication between host 110 and mobile device 120, the mobile device may request a change of network address. For example, the mobile device may have roamed or may be about to roam into another network where the current network address is no longer valid, thus requiring a network handover. This network handover may result because the current wireless network is now unreachable, the signal strength or tariff offered by another network is better, or for any other such factors. In addition, the change of network address may have occurred because the mobile device temporarily lost connection with current network. In any case, mobile device 120 may no longer be reachable, or will soon become unreachable at the mobile device's old network address.

To initiate a change of network address, mobile device 120 notifies MH 130 of the change of address via change of address request 129, as illustrated in FIG. 1G. Mobile device 120 makes the change of address request by providing to MH 130, over the established link, the secret ID, its old network address, and a new network address corresponding to the new location of the mobile device on the network (e.g., the network address by which the network into which the mobile device roamed can now be reached). For example, network 150 may include a first network serviced by a first network provider and a second network serviced by a second network provider. Mobile device may have roamed from the first network to the second network where the old network address is no longer valid and a new network address is required. The MH then uses the information provided by the mobile device to authenticate the identity of the mobile device and notify the host of the change of address.

There are a number of ways in which the change of address transaction between the mobile device and the MH may be conducted. In particular, whether the mobile device is voluntarily requesting the network address change or is being forced to do so due to the prevailing network conditions (e.g., the mobile device may have inadvertently lost its connection to the old network due to roaming, low signal strength, and/or other such factors), may determine how the change of address transaction between the MH and the mobile device is achieved.

In one embodiment, the mobile device remains connected (or re-connects) to the MH using its old network address, making the change of address over the existing connection with the MH. Typically, this transaction is conducted when the mobile device voluntarily makes the change of address, though this transaction is not limited to the voluntary scenario. In another embodiment, the mobile device disconnects from MH 130, changes its address locally, and then reconnects to the MH using the new network address, making the change of address request over a new connection established using the new network address.

MH 130 then authenticates the request, verifying that the mobile device is authorized to make the requested change of address. Once the request has been verified, MH 130 notifies host 110 that the currently established connection between the host and the mobile device has changed, or is about to change, and forwards the new network address 119 to the host, as illustrated in FIG. 1H. The notification transaction between MH 130 and host 110 may be conducted in numerous ways. For example, the notification process may depend on whether the change of address request by the mobile device was voluntary or involuntary. If mobile device 120 disconnects from the MH 130, the MH may signal to host 110 to temporarily stop delivering network packets or datagrams to the mobile device over the established connection between the mobile device and the host to avoid sending packets to the wrong address. The host may then wait for the MH 130 to forward along the new network address before resuming sending network packets to the mobile device.

As shown in FIG. 1I, host 110 establishes a connection or adjusts its connection state with mobile device 110 using the new network address provided by MH 130. Once the change of address is completed, host 110 and mobile device 120 communicate directly without intervention from MH 130, until and if another change of address is requested by the mobile device. That is, subsequent communications are routed over a communication path that does not include the MH. Thus, MH may operate as an intermediary only during the establishment of the initial connection and when enacting a change of network address.

It should be appreciated that the connection between a mobile device and host may therefore be direct, and thus independent of how often the mobile device changes network addresses and independent of which network a mobile device roams to. As a result, delivery of information between the host and mobile device may be optimized for least-cost routes between mobile devices and hosts and need not be routed through third party networks and/or hosts (e.g., routed through a home network/home agent, foreign agent, etc.). Therefore, network efficiency may be optimized and a highly scalable solution to network mobility may be provided.

The mobility mechanism described above in connection with FIG. 1 may also be highly trustworthy and secure. The mobile device and the host have been connected to the MH in a secure manner before address changes take place between the mobile device and host, making the possibility of a malicious attack unlikely. For example, in conventional mobility networks, a host and/or mobile device may know nothing about the foreign agent advertising on a particular network. By contrast, the MH may be trusted by both parties and may intervene when it is necessary to establish a connection and/or conduct a change of address. Thus, any level of security/authentication may be conducted during such transactions. Secure and seamless establishment of connections and change of network address procedures may be achieved by having a known and trusted intermediary perform such transactions.

In addition, mobility networks in accordance with various aspects of the present invention may be implemented without requiring substantial additions to the network infrastructure. In particular, home and foreign agents are not required to ensure that a mobile device can continue to communicate when roaming across different networks. Moreover, mobility networks according to aspects of the present invention may be compliant with, but need not be dependent on, the IP protocol, or any particular underlying protocol. Thus, such mobility networks may be implemented ubiquitously. Since no mobility agents need to be implemented, a mobile device may be able to roam to any network, even networks that are not compliant with the conventional framework.

It should be appreciated that the above stated benefits are merely desired effects of certain embodiments of the present invention. The aspects of the invention are not limited for use with mobility networks that achieve any one or combination of the intended benefits, although any or all of the mentioned benefits may be realized.

It should be appreciated that the host may be a mobile device as well. In particular, the connection established with the assistance of the MH, operating as an intermediary, may be between two mobile devices, a mobile device and a host connected wirelessly to an untrusted network, a mobile device and a host wired to the untrusted network, or any combination thereof. In one embodiment, the mobile device is connected to a plurality of hosts and the MH notifies each of the plurality of hosts upon a change of address request made by the mobile device. Any configuration of mobile devices, hosts, servers, etc., may be used, as the aspects of the invention are not limited in this respect.

Various aspects of the invention may be used in network configurations wherein one or more hosts are located behind a firewall. In particular, the MH intermediary may be used to achieve communications between a mobile device and a host (e.g., a server) who may not be contacted directly due to its location on a private network protected by a firewall. For example, U.S. patent application Ser. No. 11/104,982 ('982), entitled “System and Method for Automatically Initiating and Dynamically Establishing Secure Internet Connections Between a Fire-walled Server and a Fire-walled Client,” filed on Apr. 12, 2005, describes various network configurations where one or more servers are part of a private network connected to an untrusted network via a firewall, which may include a Network Address Translation (NAT) router. In particular, the session control server (SCS) described in the '982 application may operate as a MH, receiving a change of address request and notifying one or more servers of the change of address request as illustrated in FIG. 1. It should be appreciated that the embodiments described in the '982 application are not limiting, and are merely exemplary network configurations with which aspects of the present invention may be used.

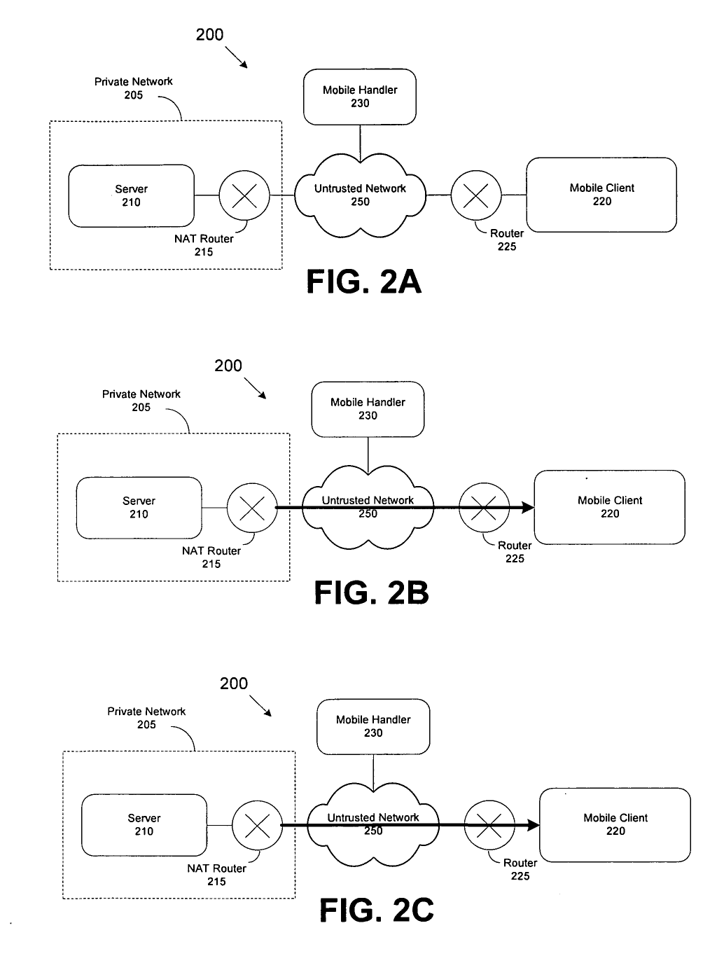

FIG. 2A illustrates a system for achieving network mobility, in accordance with one embodiment of the present invention. System 200 may be similar to system 100 illustrated in FIG. 1. However, host 110 is a server 210 located behind a firewall, wherein the private network address of server 210 is generally unknown to devices outside of private network 205. Private network 205 may be, for example, a corporate intranet, or some other local area network (LAN) that may not be directly addressable from outside the LAN. Private network 205 is connected to the untrusted network (e.g., the Internet) through NAT router 215. It may be desirable for private network 205 to be made available on some limited and secure basis to one or more mobile clients outside of the private network. For example, a corporate LAN may want to provide email or other services to employees when they are outside the office and not directly connected to the corporate LAN. The NAT router 215, in combination with MH 230, may be used to achieve secure outside access, and to facilitate relatively seamless and secure network mobility for mobile clients connected to the private network, as discussed in further detail below.

Typically, NAT router 215 stores a NAT table that translates network addresses received at the router from outside the private network to the private network address of the destination server on the private network. Accordingly, the NAT router hides the private network address of the servers on the private network and may operate as a gate keeper, allowing certain network packets to be routed to servers on the private network while ignoring others. In this capacity, the NAT router functions as an integral part of a firewall. The NAT router itself has a network address that may or may not be known to the public (e.g., other hosts and devices connected to the untrusted network). In any event, communications with the private network pass through the NAT router.

In the configuration of FIG. 2, the MH may operate as a trusted intermediary to facilitate establishing secure communications between mobile client 220 and server 210, and to effect secure and dynamic changes of network addresses. For example, to establish an initial connection between mobile client 220 and server 210, the operations described in connection with FIGS. 1B-1D may be performed. In particular, server 210 and mobile client 220 may each establish a connection with MH 230. MH 230 and mobile client 220 exchange information to uniquely and securely identify the client. MH 230 then notifies server 210, via NAT router 215, that mobile client 220 desires to connect to server 210, for example, to access one or more services provided by server 210. Because MH 230 is trusted by the private network, it may agree to provide one or more services to the mobile client. However, because the private network has an interest is keeping internal private network addresses private, server 210 may operate in conjunction with NAT router 215 to establish a connection with the client without releasing internal network address information.

As shown in FIG. 2B, server 210 initiates a transaction to establish a connection between the server and mobile client 220. Since mobile client does not know the private network address of the server, the mobile client cannot by itself establish a connection with the server. As such, the server may contact the mobile device with a temporary network address at which the server may be contacted. NAT router 215 may then associate the temporary network address with the private network address of the server. Moreover, the NAT router may be instructed to only route information received at the temporary network address to the private network address if the information was received from the network address of mobile client 220 (as provided by the MH). Thus, a connection may be established between the server and the mobile client without the mobile client ever learning the private address of the server.

At some point after the connection has been made between server 210 and mobile client 220, mobile client 220 may make a change of address request to the MH. The change of address transaction with the MH may be conducted as described in connection with FIG. 1. That is, the mobile client may provide the secret ID provided by the MH along with the new network address at which the mobile client can be reached. Alternatively, if the mobile client has already switched networks, lost connection with the current network, and/or was otherwise involuntarily forced from the network, the mobile client may re-connect to the MH using its new network address. The MH, after authenticating the mobile client, may notify the server of the change of address request and provide the server with the new network address of the mobile client.

As shown in FIG. 2C, the server initiates a transaction to re-establish a connection or to adjust the connection with the mobile client. For example, server 220 may repeat the procedure described above in connection with FIG. 2B using the new network address of the mobile client. The server may choose to issue a new temporary address for the NAT router to associate with the new network address of the mobile client. Alternatively, the NAT table may be notified of the new network address and modified to only route communications from the new network address to the private network address of server 210. Other mechanisms may be used to re-establish and/or adjust the connection between the server and the mobile client, as the aspects of the invention are not limited in this respect.

It should be appreciated that the mobile client may have a NAT router through which it interfaces with the untrusted network, may itself be part of a private network and/or protected by a firewall, etc., as the aspects of the invention are not limited for use with any particular network configuration. As discussed above, the mobile device (e.g., the mobile client) may communicate with any number of hosts (e.g., servers). These servers may be part of private networks, directly connected and accessible via the untrusted network, or in any other network configuration, as the aspects of the invention are not limited in this respect.

It should be appreciated that, unlike the conventional framework described in the background which is implemented in the network layer (layer 3 of the ISO stack), the above described techniques may be implemented in the application layer, independent of the underlying protocols (including the IP protocol), allowing the aspects of the invention to be used in connection with any type of network. For example, the change of address techniques described above can be implemented beneath the transport layer via the NAT or at the application layer via explicit transport layer re-connects following address changes by the mobile device. However, the change of address may be implemented in other layers, as the aspects of the invention are not limited in this respect.

The Applicant has appreciated that aspects of the invention facilitate mobility for portable stateless devices. A stateless device refers herein to a device that can operate substantially as a network and display management device. In particular, the stateless device may operate chiefly as a human interface device to a network when operating in its stateless capacity. A stateless device typically does not run any applications other than software that performs network functionality and displays information received over the network. As a result, a stateless device (when operating in its stateless capacity) need not perform substantial user functionality and/or contain any significant and/or permanent user data.

Enabling a stateless device to access, interact with and/or receive services from other network devices mitigates and/or eliminates one or more problems associated with conventional network computing. For example, state-full computing devices are largely responsible for a number of security issues such as providing user functionality that facilitates hacking, establishing a computational environment to both host and spread viruses, and/or otherwise enabling a user to breach security, attack vulnerabilities in a network environment, and/or otherwise exploit the functionality of state-full devices.

A stateless device, by contrast, is largely stripped of the functionality that facilitates the various capabilities described above. However, a stateless device in conjunction with the above described architecture, permit the stateless device to operate as a so-called “dumb terminal,” yet still benefit from resources available over the network. In particular, a stateless device may simulate any computing environment without requiring the device itself to be enabled with the associated functionality. For example, a stateless device, interacting with a network service, may operate as a Windows™ device without requiring the Windows™ operating system to be installed on the stateless device. Since the stateless device is operating as an interface to the network, it may be presented information over the network that allows it to simulate any device or functionality, without requiring the attendant drawbacks associated with the requirement that the functionality be resident on the stateless device. Stateless devices facilitate a shift in network computing from a paradigm in which the computational and functional burden is on the device connecting to the network (e.g., a laptop or PC) to a paradigm in which functionality and computation may be chiefly performed by servers connected to the network. Amongst some of the advantages described above, this new paradigm allows devices that traditionally do not enjoy, or enjoy limited network capabilities (e.g., televisions, or any other device having a display) to become fully network capable devices. Stateless devices present a relatively inexpensive means to fully interact with and access services over one or more networks, while preserving the integrity of data maintained by hosts/servers to which the stateless device is interacting/interfacing.

It should be appreciated that a state-full device (such as a personal computer, personal digital assistant, etc.) may operate in a stateless capacity. That is, a state-full device may operate as a stateless device by suppressing, to some extent, its full capability as a state-full device such as executing applications, storing user data and information, etc. Purely stateless devices, though, operate substantially as a network appliance that allow a user to interface with information on a network that is stored elsewhere, and/or to receive services and functionality that is computed, performed and provided from some other location on the network (e.g., by one or more hosts or servers to which the network appliance is connected).

The Applicant has recognized that trends towards increasingly mobile networks, telecommuting, and a desire and/or necessity for seamless access to information from anywhere in a mobile environment, etc., generate an environment where stateless mobile devices are of distinct benefit. For example, various aspects of the invention facilitate the use of a mobile stateless device as an interface to the network. The user of the mobile stateless device may interact with the network, for example, a private network, as if the stateless device were connected within the private network (e.g., behind the firewall). Thus, mobile stateless device users can use services provided by servers of a particular network, substantially as if the user were locally connected to the servers. The mobility networks described above facilitate implementation of mobile stateless devices in a seamless, secure and scalable manner, as discussed in further detail below.

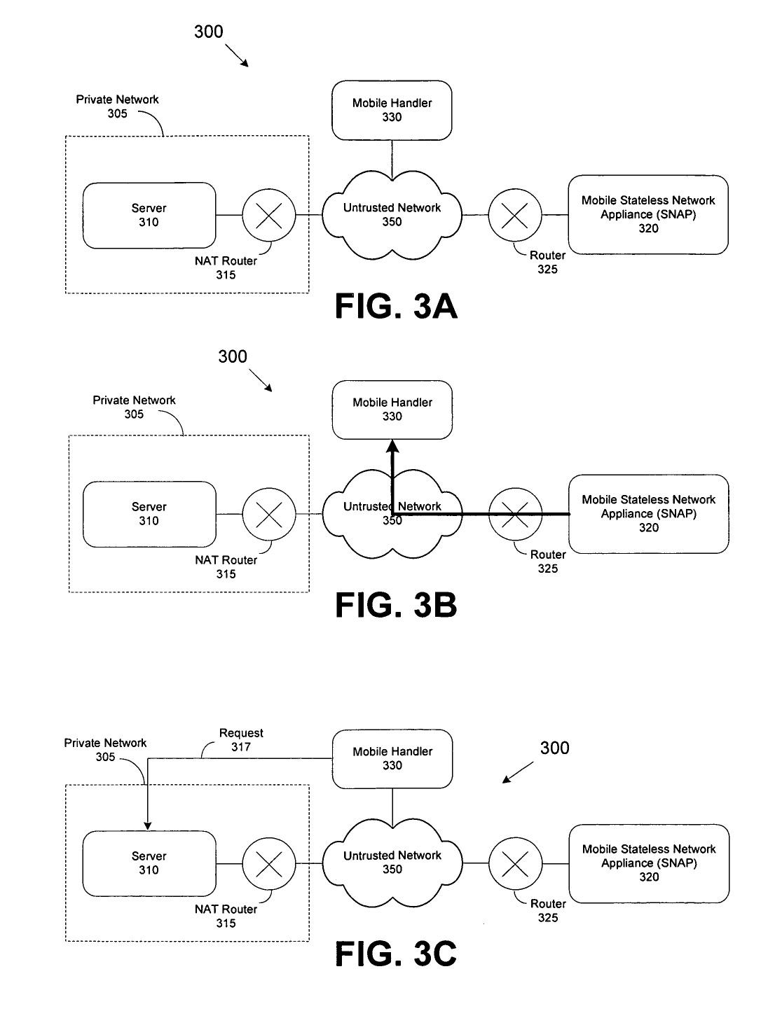

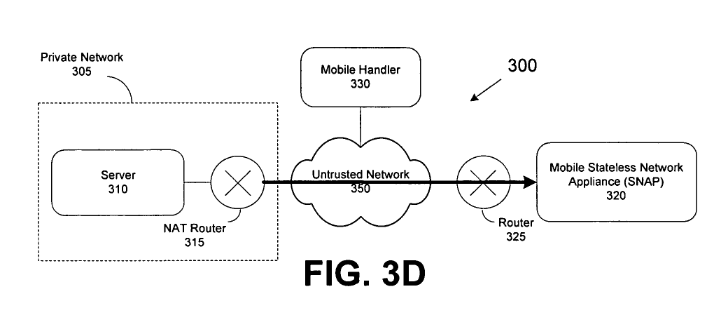

FIG. 3 illustrates a mobility network including a mobile stateless device, in accordance with one embodiment of the present invention. Mobility network 300 may be similar to network 200 described in FIG. 2. However, mobility network 300 may include a stateless network appliance (SNAP) 320. SNAP 320 may be a purely stateless device or may be a state-full network device capable of operating in a substantially stateless capacity. In particular, SNAP 320 may be any device capable of performing network activity such as receiving and transmitting network packets over untrusted network 350, and displaying information received over the network (e.g., from MH 330, server 310, etc.).

In one embodiment, SNAP 320 includes one or more processors such as a central processing unit (CPU), a memory, a frame-buffer, a network port, an input device such as a keyboard, keypad, mouse, touch-sensitive screen, etc., and a display to present information received from the network to the user. As discussed above, SNAP may include other components used in state-full devices, but the above listed components are sufficient for the SNAP to communicate over the untrusted network in a mobile environment. In particular, the components need only be sufficient to allow the SNAP to exchange network information, display information received from the network, and allow the user to interact with the display (e.g., via one or more input devices).

As shown in FIG. 3B, the SNAP contacts MH 330 to request a connection with server 310. For example, SNAP 320 may include software that implements a network stack to allow communications with devices over the network. In embodiments wherein SNAP 320 is purely stateless, SNAP 320 may be configured to automatically contact and connect to MH 330 upon start-up (since, apart from the network, a purely stateless SNAP has little or no functionality).

In much the same manner as described in connection with FIGS. 1 and 2, a network connection (e.g., an encrypted link such as an SSL or TCP/IP connection) may be established between SNAP 320 and MH 330 and a unique identifier is exchanged to facilitate security (e.g., SNAP 320 provides its network address and the MH generates and sends a secret ID to the SNAP). MH 330 then notifies server 310 that SNAP 320 would like to connect to the server and provides the server with the network address of SNAP 320, as shown in FIG. 3C. Server 310 may then transmit a temporary address to the SNAP that it can use to establish a link between the server and the SNAP so that the SNAP can communicate with the server behind the firewall (e.g., as if the SNAP were directly connected to private network 305, as shown in FIG. 3D).

In this manner, a stateless device may be used to access one or more services provided by a server located within a private network (e.g., a corporate LAN protected behind a firewall). If the SNAP needs to change its network address for any reason (e.g., because it has roamed to a new network having a new network provider, has roamed to a location where the signal strength or tariff of another network is preferable, has temporarily lost connection with the network, etc.), SNAP 320 provides a change of address request to MH 330 which relays the request to server 310, who then begins communicating with the SNAP at the new network address. Thus, a SNAP may obtain new network addresses automatically, securely, seamlessly and dynamically without user intervention. Accordingly, the stateless device may receive one or more services, and/or interact with private network 305 from any location and/or in a highly mobile environment.

It should be appreciated that SNAP 320 need not rely on features and/or components associated with traditional state-full devices such as personal computers, cellular telephones, etc. For example, SNAP 320 need not include persistent storage capabilities to save client specific information, application state information, etc. The only relevant state information pertains to temporary state information related to network connectivity (e.g., TCP connection state, etc.). The SNAP need not be capable of (and in some cases may be prevented from) downloading data or uploading data to the network. For example, services used by the SNAP may be provided entirely server-side, and the server may transmit purely display information to the SNAP (e.g., as discussed in the '660 and '982 applications). Thus, the SNAP need not store and/or itself modify any information belonging to the private network, allowing for secure mobile interaction between the SNAP and the server by protecting the information available within the private network, while still providing service to the SNAP.

In addition, there need not be any association with the user of the SNAP since there is no required association between the mechanism and the user's identity. Moreover, no association with any of the servers with which it communicates is required, including the identity of the servers or the data received from them.

It should be appreciated that a mobile stateless device may connect to a host directly connected to the untrusted network, such as the host 110 described in connection with FIG. 1. Any of the components of the mobility networks described above may be used in any combination, number and/or configuration, as the aspects of the invention are not limited in this respect.

The above-described embodiments of the present invention can be implemented in any of numerous ways. For example, the embodiments may be implemented using hardware, software or a combination thereof. When implemented in software, the software code can be executed on any suitable processor or collection of processors, whether provided in a single computer or distributed among multiple computers. It should be appreciated that any component or collection of components that perform the functions described above can be generically considered as one or more controllers that control the above-discussed function. The one or more controller can be implemented in numerous ways, such as with dedicated hardware, or with general purpose hardware (e.g., one or more processor) that is programmed using microcode or software to perform the functions recited above.

It should be appreciated that the various methods outlined herein may be coded as software that is executable on one or more processors that employ any one of a variety of operating systems or platforms. Additionally, such software may be written using any of a number of suitable programming languages and/or conventional programming or scripting tools, and also may be compiled as executable machine language code.

In this respect, it should be appreciated that one embodiment of the invention is directed to a computer readable medium (or multiple computer readable media) (e.g., a computer memory, one or more floppy discs, compact discs, optical discs, magnetic tapes, etc.) encoded with one or more programs that, when executed on one or more computers or other processors, perform methods that implement the various embodiments of the invention discussed above. The computer readable medium or media can be transportable, such that the program or programs stored thereon can be loaded onto one or more different computers or other processors to implement various aspects of the present invention as discussed above.

It should be understood that the term “program” is used herein in a generic sense to refer to any type of computer code or set of instructions that can be employed to program a computer or other processor to implement various aspects of the present invention as discussed above. Additionally, it should be appreciated that according to one aspect of this embodiment, one or more computer programs that when executed perform methods of the present invention need not reside on a single computer or processor, but may be distributed in a modular fashion amongst a number of different computers or processors to implement various aspects of the present invention.

Various aspects of the present invention may be used alone, in combination, or in a variety of arrangements not specifically discussed in the embodiments described in the foregoing and is therefore not limited in its application to the details and arrangement of components set forth in the foregoing description or illustrated in the drawings. The invention is capable of other embodiments and of being practiced or of being carried out in various ways. In particular, various aspects of the present invention may be implemented in connection with any type, collection or configuration networks. No limitations are placed on the network implementation. Accordingly, the foregoing description and drawings are by way of example only.

Use of ordinal terms such as “first”, “second”, “third”, etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Also, the phraseology and terminology used herein is for the purpose of description and should not be regarded as limiting. The use of “including,” “comprising,” or “having,” “containing”, “involving”, and variations thereof herein, is meant to encompass the items listed thereafter and equivalents thereof as well as additional items.

What is claimed is:

1. A method for changing a first network address of a mobile device connected to a network at a first network address, the mobile device having a connection to a host over the network, the change of network address being processed by a mobile handler connected over the network to both the mobile client and the host, the method comprising acts of:
transmitting a change of address request, from the mobile device to the mobile handler, the change of address request including a second network address;
providing a notification of the change of address request, from the mobile handler to the host, the notification including the second network address;
modifying, by the host, the connection between the host and the mobile client to use the second network address in communicating with the mobile client; and
communicating between the host and the mobile client over the modified connection, wherein a communication path of the modified connection does not include the mobile handler.

2. The method of claim 1, wherein the network includes a first network and a second network, the method further comprising an act of:
roaming, by the mobile device, from the first network to the second network, wherein the second network address corresponds to a location of the mobile device on the second network.

3. The method of claim 2, further comprising acts of:
prior to the act of transmitting the change of address request:
transmitting a connection request, by the mobile device to the mobile handler, the connection request including the first network address;
providing a notification of the connection request, by the mobile handler to the host, the notification including the first network address of the mobile device; and
establishing a connection, initiated by the host, between the host and the mobile device at the first network address,
wherein a communication path over the connection does not include the mobile handler.

4. The method of claim 3, further comprising an acts of:
providing, by the mobile handler to the mobile device, an identifier that identifies the mobile device to the mobile handler, and wherein the transmitting the change of address request includes an act of transmitting the change of address including the identifier; and
authenticating, by the mobile handler, the mobile device based, at least in part, on the identifier.

5. The method of claim 1, wherein the host is a first server connected to a local area network (LAN), the LAN having accessibility from the network limited by a network address translation (NAT) router having a NAT table that translates network addresses received from the network to private network addresses corresponding to locations of at least one server on the LAN, and wherein the private network address of the first server is unknown to the mobile client.

6. The method of claim 5, wherein the act of modifying the connection between the host and the mobile client includes an act of updating the NAT table such that communications received from the second network address are routed to the first server.

7. A system capable of performing network address changes, the system comprising:
a network interconnecting a plurality of hosts;
a mobile device connected to the network, the mobile device associated with a first network address corresponding to a first network location of the mobile device on the network;
a first host connected to the network; and
a mobile handler capable of communicating with the mobile device and the host over the network,
wherein the mobile handler is configured to receive a change of address request from the mobile device, the change of address request including a second network address corresponding to a second network location of the mobile device on the network, the mobile handler configured to notify the first host of the change of address request, the notification including the second network address, and
wherein the first host is adapted to receive the notification and to initiate a connection with the mobile device at the second network address, wherein a communication path of the connection does not include the mobile handler.

8. The system of claim 7, wherein the network comprises at least a first network and a second network, wherein the mobile device is capable of attaching to either the first network and the second network, and wherein the mobile device is configured to transmit the change of address request when the mobile device roams from the first network to the second network, the first network location associated with the first network and the second network location associated with the second network.

9. The system of claim 7, wherein the mobile handler is configured to receive a connection request from the mobile device to connect to the host, and wherein, in response to receiving the connection request, the mobile handler provides an identifier to the mobile device to, at least temporarily, identify the mobile device.

10. The system of claim 9, wherein the mobile device is configured to include the identifier as part of the change of address request, and wherein the mobile handler is configured to authenticate the mobile device based, at least in part, on the identifier.

11. The system of claim 10, wherein the mobile handler is configured to notify the host of the change of address request only after the mobile device has been authenticated.

12. The system of claim 9, wherein the mobile handler is configured to notify the host of the connection request and provide the host with the first network address of the mobile device at which the mobile device.

13. The system of claim 12, wherein the first host is connected to a private local area network (LAN) located behind a firewall, the first host having a private network address on the LAN that is unknown to the mobile device, and wherein the host is configured to initiate a connection with the mobile device using the first network address provided by the mobile handler.

14. The system of claim 13, further comprising a network address translation (NAT) router, the NAT router being part of the firewall, wherein the NAT router includes a NAT table that translates network addresses received from the network to respective private addresses of the private LAN.

15. The system of claim 14, wherein the first host, when initiating the connection with the mobile device at the first network address, issues a temporary network address associated with the first host, and wherein the NAT router associate, in the NAT table, the temporary network address with the private network address of the first host such that the mobile device can communicate with the first host via the NAT router.

16. The system of claim 9, wherein the mobile device is a stateless device and is configured to automatically provide a connection request upon start-up.

17. A network device for facilitating a change in a first network address of a mobile device having a connection to a host over a network, wherein the connection uses a first network address for the mobile device, the network device comprising:
at least one network port to allow the network device to be connected to the network;
a controller connected to the at least one network port, the controller adapted to process a change of address request received at the at least one network port from the mobile device, the change of address request including a second network address, the controller further adapted to transmit at least the second network address to the host to notify the host of the change of address request,
wherein subsequent communications between the host and the mobile device over a connection established at the second network address is over a communication path that does not include the network device.

18. The network device of claim 17, wherein the controller includes an authentication portion that verifies, from the change of address request, authenticity of the mobile device.

19. The network device of claim 18, wherein the first controller is adapted to process a connection request received at the at least one network port from the mobile device, the connection request including the first network address of the mobile device, and wherein the first controller, in response to receiving the connection request, transmits at least the first network address to the host,
wherein subsequent communications between the host and the mobile device over a connection established at the first address is over a communication path that does not include the network device.

20. The network device of claim 19, wherein the controller, in response to the connection request, generates an identifier and transmits the identifier to the mobile device, and wherein the change of address request includes the identifier, the authentication portion verifying the authenticity of the mobile device based, at least in part, on the identifier.
